(19) United States
(12) Patent Application Publication
(10) Pub. No.: US 2017/0132601 A1
(43) Pub. Date: May 11, 2017

(54) INFORMATION PROCESSING DEVICE AND MANAGEMENT SYSTEM

(71) Applicant: TOSHIBA TEC KABUSHIKI KAISHA, Tokyo (JP)

(72) Inventors: Akiko Susaki, Ota Tokyo (JP); Tsuyoshi Gotanda, Ota Tokyo (JP); Norifumi Shishido, Mishima Shizuoka (JP)

(21) Appl. No.: 15/343,597

(22) Filed: Nov. 4, 2016

(30) Foreign Application Priority Data
Nov. 5, 2015 (JP) 2015-217708

(51) Int. Cl. G06Q 20/20; G06Q 10/08

(52) U.S. Cl. CPC G06Q 20/203; G06Q 10/087

(57) ABSTRACT

The information processing device includes a first reception means, a generation means, and a first transmission means. The first reception means receives individual state information indicating a state of an accounting device performing accounting processing on merchandise on which sales registration is performed as the merchandise for a sales target from a plurality of accounting devices. The generation means generates entire state information indicating a state of each of the plurality of accounting devices received the individual state information by the first reception means, by aggregating the individual state information. The first transmission means transmits the entire state information generated by the generation means to a portable terminal including a display unit.

### CROSS-REFERENCE TO RELATED APPLICATIONS

This application is based upon and claims the benefit of priority from Japanese Patent Application No. 2015-217708, filed Nov. 5, 2015, the entire contents of which are incorporated herein by reference.

### FIELD

Embodiments described herein relate generally to an information processing device and a management system and methods associated therewith.

### BACKGROUND

In the related art, in a store such as a supermarket and the like, there is a self-checkout system by which a customer performs for himself or herself merchandise sales data processing of merchandise as an operator. The self-checkout system includes a self-point of sales (POS) terminal by which the customer performs sales registration of merchandise, and an information processing device (attendant terminal) that manages a state of the self-POS terminals installed in the store. Accordingly, the attendant terminal is installed at a location overlooking the self-POS terminal to be managed by the attendant terminal.

In addition, there is also a case where an attendant terminal is introduced into a semi-self-checkout system in which the sales registration of merchandise is performed by a clerk, but accounting processing is performed by a customer, in the merchandise sales data processing. In the case where the attendant terminal is introduced into the semi-self-checkout system, the attendant terminal monitors an accounting device that performs the accounting processing by the customer to be the operator.

In these checkout systems, the clerk appropriately checks the information processing device in order to recognize a state such as a change and the like of the self-POS terminal or the like, or cope with an error generated in the self-POS terminal or the like.

However, the clerk is busy, and also performs customer service, the shipment of merchandise, or the like which hinders his/her ability to assist in matters requiring immediate human attention. Therefore, the clerk has to go a location at which the information processing device is installed for every case, in order to check the state of the self-POS terminal or the like.

### DESCRIPTION OF THE DRAWINGS

FIG. 1 is an explanatory diagram illustrating an example of a configuration of a self-checkout system according to an embodiment.

FIG. 2 is a perspective view of an appearance of a self-POS terminal seen from an operator side.

FIG. 3 is a block diagram illustrating a hardware configuration of the self-POS terminal.

FIG. 4 is a block diagram illustrating a hardware configuration of an attendant terminal.

FIG. 5 is a block diagram illustrating a hardware configuration of a portable terminal.

FIG. 6 is a block diagram illustrating a function configuration included in each device of a self-checkout system.

FIG. 7 is an explanatory diagram illustrating an example of a first management screen.

FIG. 8 is a flowchart illustrating an example of management processing.

### DETAILED DESCRIPTION

An object of the invention is to provide the information processing device and the management system which can easily check the state of the self-POS terminal or the like.

The information processing device of the embodiment includes first reception means, generation means, and first transmission means. The first reception means receive individual state information indicating a state of an accounting device performing accounting processing on merchandise on which sales registration is performed as the merchandise for a sales target from a plurality of accounting devices. The generation means generate entire state information indicating a state of each of the plurality of accounting devices received the individual state information by the first reception means, by aggregating the individual state information. The first transmission means transmit the entire state information generated by the generation means to a portable terminal including a display unit.

Hereinafter, with reference to accompanying drawings, an embodiment of an information processing device and a management system will be described in detail. The embodiment described below is an embodiment of the information processing device, and does not limit a configuration or specification thereof. The information processing device of the embodiment is an application example of an attendant terminal that is introduced in a store such as a supermarket and the like, and manages a self-point of sales (POS) terminal by which a customer performs registration and settlement of merchandise according to one transaction.

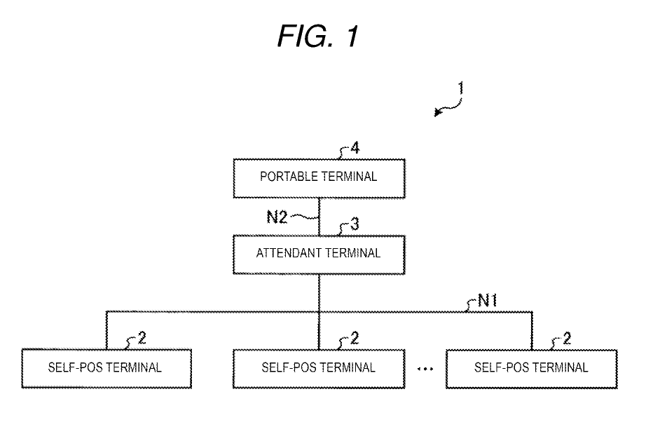

FIG. 1 is an explanatory diagram illustrating an example of a configuration of a self-checkout system 1 according to the embodiment. The self-checkout system 1 includes self-POS terminals 2, an attendant terminal 3, and a portable terminal 4. In addition, the self-checkout system 1 according to the embodiment is a management system in which the attendant terminal 3 and the portable terminal 4 manage the self-POS terminal 2.

The self-POS terminal 2 is a merchandise sales data processing device by which a customer performs an operation according to the merchandise sales data processing at a store such as a supermarket and the like. Accordingly, the self-POS terminal 2 is also an accounting device by which a customer performs sales registration processing for registering merchandise for a sales target, and accounting processing of the merchandise on which sales registration is performed as the merchandise for a sales target, in the merchandise sales data processing.

The attendant terminal 3 is the information processing device that manages the self-POS terminal 2. The attendant terminal 3 is installed at a position overlooking the self-POS terminal 2 managed by the attendant terminal 3, in a store such as the supermarket and the like. For example, the attendant terminal 3 is a notebook type personal computer. In addition, the attendant terminal 3 is connected to the self-POS terminal 2, through a network N1. The network N1 is connected by a wire such as a local area network (LAN) cable. Accordingly, the attendant terminal 3 can display various states of the self-POS terminal 2 connected through the network N1. In addition, the attendant terminal 3 aggregates information transmitted from the self-POS terminal 2, and transmits the aggregated information to the portable terminal 4. Furthermore, the attendant terminal 3 can transmit various types of remote operation information for remotely operating the self-POS terminal 2. The network N1 is not limited to the wire such as the LAN cable and the like, and may be wireless. In addition, the self-checkout system 1 does not limit one attendant terminal 3, and may be provided with plural terminals.

The portable terminal 4 is a portable tablet terminal that manages the self-POS terminal 2. A shoulder belt or the like is provided in the portable terminal 4, and the portable terminal 4 can be easily carried even if performing various operations by a clerk. The portable terminal 4 is connected to the attendant terminal 3, through a network N2. The network N2 is connected by wireless using wireless LAN or the like. Accordingly, the portable terminal 4 can display all or a part of various states of each of the self-POS terminals 2 by receiving the information aggregated by the attendant terminal 3. In addition, the portable terminal 4 can transmit various types of remote operation information for remotely operating the self-POS terminal 2, through the attendant terminal 3. In addition, the self-checkout system 1 does not limit one portable terminal 4, and may be provided with plural terminals.

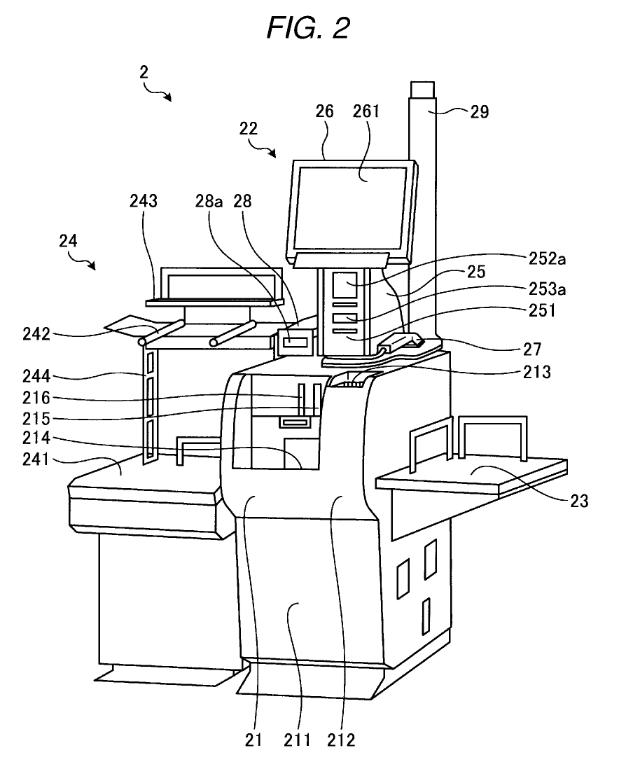

Next, the self-POS terminal 2 using FIG. 2 will be described. FIG. 2 is a perspective view illustrating the appearance of the self-POS terminal 2 seen from an operator side.

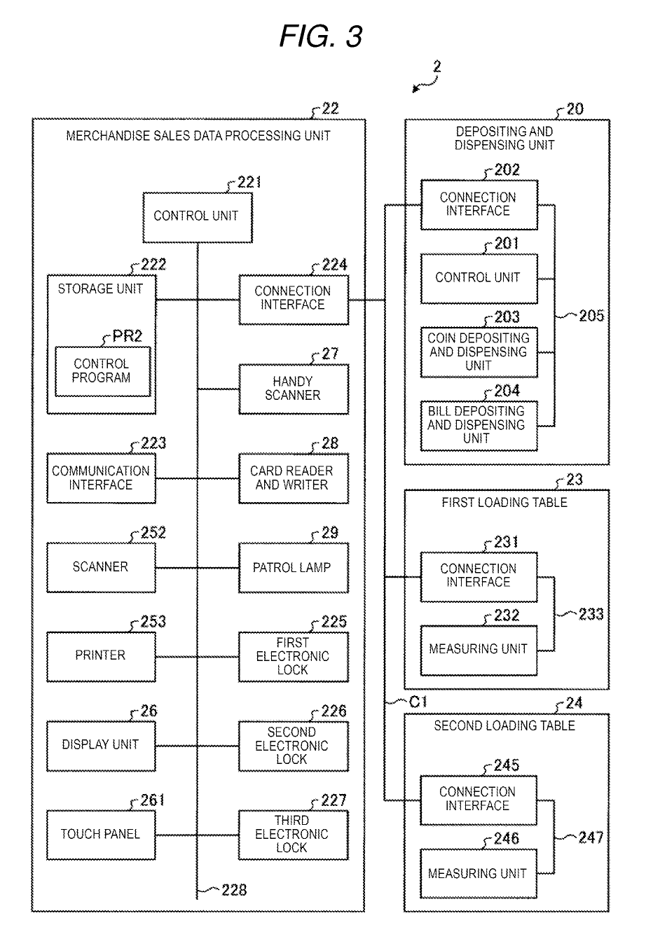

The self-POS terminal 2 includes a first housing 21 incorporating a depositing and dispensing unit 20 (see FIG. 3) in the front center and a merchandise sales data processing unit 22 placed on an upper surface of the first housing 21. In addition, the self-POS terminal 2 includes a first loading table 23 on which a basket filled with merchandise which is not registered as the merchandise of the sales target is placed, on the front right side. In addition, the self-POS terminal 2 includes a second loading table 24 on which a basket filled with merchandise which is registered as the merchandise of the sales target is placed, on the front left side. The self-POS terminal 2 illustrated in FIG. 2 includes one first loading table 23 and one second loading table 24. However, the self-POS terminal 2 may include plural tables.

The second loading table 24 includes a pedestal 241 on which the merchandise registered as the merchandise of the sales target is placed. In addition, the second loading table 24 includes a bag hook 242 for hanging a bag to which the merchandise registered as the merchandise of the sales target is input, and a temporary placing table 243 of the merchandise on which sales registration processing is performed. The bag hook 242 and the temporary placing table 243 are supported on a strut 244 provided in the pedestal 241 and positioned on upper portion of the pedestal 241.

In addition, the first loading table 23 and the second loading table 24 include measuring units 232 and 246 (see FIG. 3), respectively. With this, the first loading table 23 and the second loading table 24 can confirm that the weight of the merchandise before and after the settlement is the same.

The first housing 21 includes a first housing lower cover 211 and a first housing upper cover 212. The first housing lower cover 211 is a cover for covering a lower portion of the first housing 21. The first housing upper cover 212 is a cover for covering an upper portion of the first housing 21. Accordingly, the first housing 21 can open the first housing upper cover 212 on the condition that the first housing lower cover 211 is open. In addition, the first housing 21 includes a first electronic lock 225 (see FIG. 3) for locking the first housing lower cover 211, and a second electronic lock 226 (see FIG. 3) for locking the first housing upper cover 212.

The first housing 21 includes the depositing and dispensing unit 20 inside which the first housing upper cover 212 opened and closed. The depositing and dispensing unit 20 accommodates the currency such as payment, change, and the like of the merchandise. In addition, the first housing 21 includes a coin slot 213, a coin payout opening 214, a bill slot 215, and a bill payout opening 216. The coin slot 213 is a deposit port for depositing the coins in the depositing and dispensing unit 20 as the payment of the merchandise. The coin payout opening 214 is a dispensing port of the coins dispensed from the depositing and dispensing unit 20 as the change. The bill slot 215 is a deposit port of the bill deposited to the depositing and dispensing unit 20 by the customer as the payment of the merchandise. The bill payout opening 216 is a dispensing port of the bill dispensed from the depositing and dispensing unit 20 as the change.

The merchandise sales data processing unit 22 includes each unit used in performing of the merchandise sales data processing. That is, the merchandise sales data processing unit 22 includes a second housing 25, a display unit 26, a handy scanner 27, a card reader and writer 28, and a patrol lamp 29.

The second housing 25 supports the display unit 26 provided on the upper portion of the second housing 25. The second housing 25 is covered with a second housing cover 251. Accordingly, the second housing 25 includes a third electronic lock 227 (see FIG. 3) for locking the opening and closing of the second housing cover 251. In addition, the second housing 25 incorporates a scanner 252 (see FIG. 3) and a printer 253 (see FIG. 3), inside the second housing cover 251.

The second housing 25 includes a reading window 252a for reading a merchandise code of the merchandise by the scanner 252. The reading window 252a transmits a laser beam emitted by the scanner 252 outside the second housing 25, and transmits a reflected light of the laser beam inside the second housing 25. The scanner 252 may read the merchandise code or the like from a captured image by capturing an image of the merchandise.

The second housing 25 includes a receipt issue port 253a for discharging a receipt or the like output by the printer 253. The printer 253 discharges a receipt on which the sales information of the merchandise on which transaction processing is performed is printed from the receipt issue port 253a on a paper.

The handy scanner 27 is a handheld scanner. The handy scanner 27 is used in a case where it is difficult to hold up the merchandise to the reading window 252a in a case where the merchandise is heavy, the merchandise is large, or the like.

For example, the display unit 26 is a liquid crystal display or the like. The display unit 26 displays the merchandise information or the like on which sales registration is performed. In addition, the display unit 26 includes a touch panel 261 (see FIG. 3) that operates the self-POS terminal 2. The touch panel 261 determines that an operation is input according to a display element displayed on the display unit 26, by detecting a location operated (touched) on the display unit 26. With this, the touch panel 261 receives an operation of a corresponding key, by operating a key displayed on the display unit 26.

The card reader and writer 28 is a device that performs reading and writing of information stored in a storage medium of the card using in the settlement of a credit card or the like. The card reader and writer 28 includes a card insertion slot 28a for inserting the card in the front surface. Accordingly, the card reader and writer 28 performs reading and writing of information stored in the storage medium of the card inserted into the card insertion slot 28a. When a series of processes are terminated, the card reader and writer 28 discharges the card that is inserted into the card insertion slot 28a.

The patrol lamp 29 is a warning light for notifying the clerk of the generation of abnormality of the self-POS terminal 2. For example, the patrol lamp 29 blinks in red color or the like in a case where the abnormality is generated in the self-POS terminal 2.

Next, details of various devices included in the self-checkout system 1 will be described.

First, a hardware configuration of the self-POS terminal 2 will be described. FIG. 3 is a block diagram illustrating a hardware configuration of the self-POS terminal 2.

The merchandise sales data processing unit 22 includes a control unit 221 integrally controls various calculations or each part of the merchandise sales data processing unit 22. Accordingly, the control unit 221 controls the entirety of the self-POS terminal 2. That is, the control unit 221 performs various types of processing by transmitting a command or the like to the depositing and dispensing unit 20, the first loading table 23, and the second loading table 24. In addition, the control unit 221 receives a performance result or the like of the various types of processing from the depositing and dispensing unit 20, the first loading table 23, and the second loading table 24.

The control unit 221 is configured by a central processing unit (CPU), a read only memory (ROM), a random access memory (RAM), a real time clock (RTC), or the like. The ROM is a storage medium for storing various programs or data. The RAM is a storage medium for temporarily storing various programs, or a storage medium for rewriting various data. The RTC counts the current date and time.

The control unit 221 is connected to a storage unit 222, a communication interface 223, the scanner 252, the printer 253, the display unit 26, the touch panel 261, the handy scanner 27, a connection interface 224, the card reader and writer 28, the patrol lamp 29, the first electronic lock 225, the second electronic lock 226, and the third electronic lock 227, through a bus 228.

For example, the storage unit 222 is a storage device such as a hard disk drive (HDD), a solid state drive (SSD), and the like. The storage unit 222 stores a control program PR2 for executing various POS operations including the merchandise sales data processing or various types of setting information. The communication interface 223 is an interface connected to the network N1. The connection interface 224 is an interface connected to the depositing and dispensing unit 20, the first loading table 23, and the second loading table 24, through a connection cable C1. The unlocking and locking of the first electronic lock 225, the second electronic lock 226, and the third electronic lock 227 are controlled by the control unit 221.

The depositing and dispensing unit 20 includes a control unit 201 integrally controls each part of the depositing and dispensing unit 20, in response to a command from the merchandise sales data processing unit 22. The control unit 201 performs various types of processing in response to a command from the merchandise sales data processing unit 22. In addition, the control unit 201 transmits an execution result of various types of processing to the merchandise sales data processing unit 22.

The control unit 201 is configured by the CPU, the ROM, the RAM, the RTC, and the like. The ROM is a storage medium for storing various programs or data. The RAM is a storage medium for temporarily storing various programs, or a storage medium for rewriting various data. The RTC counts the current date and time.

The control unit 201 is connected to a connection interface 202, a coin depositing and dispensing unit 203, and a bill depositing and dispensing unit 204, through a bus 205. The connection interface 202 is an interface connected to the merchandise sales data processing unit 22, through the connection cable C1.

The coin depositing and dispensing unit 203 accommodates the coins deposited from the coin slot 213 to a coin storage unit (not illustrated). In addition, the coin depositing and dispensing unit 203 dispenses the change from the coin storage unit to the coin payout opening 214. The bill depositing and dispensing unit 204 accommodates the bill deposited from the bill slot 215 to a bill storage unit (not illustrated). In addition, the bill depositing and dispensing unit 204 dispenses the change from the bill storage unit to the bill payout opening 216.

The first loading table 23 includes a connection interface 231 and a measuring unit 232. The first loading table 23 is connected to the connection interface 231 and the measuring unit 232, through a bus 233. The connection interface 231 is an interface connected to the merchandise sales data processing unit 22, through the connection cable C1. The measuring unit 232 is a load cell unit for measuring the weight of the merchandise placed on the first loading table 23. Accordingly, the first loading table 23 can output the weight of the merchandise placed on the first loading table 23 to the merchandise sales data processing unit 22.

The second loading table 24 includes a connection interface 245 and a measuring unit 246. The second loading table 24 is connected to the connection interface 245 and the measuring unit 246, through a bus 247. The connection interface 245 is an interface connected to the merchandise sales data processing unit 22, through the connection cable C1. The measuring unit 246 is the load cell unit for measuring the weight of the merchandise placed on the second loading table 24. That is, the second loading table 24 can output the weight of the merchandise placed on the second loading table 24 to the merchandise sales data processing unit 22.

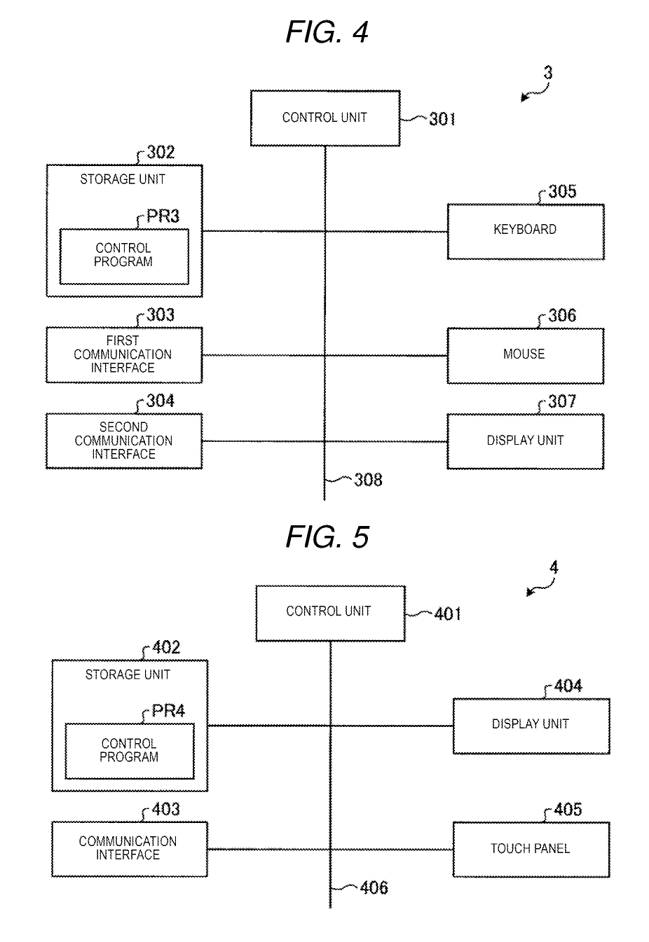

Next, a hardware configuration of the attendant terminal 3 will be described. FIG. 4 is a block diagram illustrating a hardware configuration of the attendant terminal 3.

The attendant terminal 3 includes a control unit 301 that integrally controls various calculations or each unit of the attendant terminal 3. The control unit 301 is configured by the CPU, the ROM, the RAM, the RTC, and the like. The ROM is a storage medium for storing various programs or data. The RAM is a storage medium for temporarily storing various programs, or a storage medium for rewriting various data. The RTC counts the current date and time.

The control unit 301 is connected to a storage unit 302, a first communication interface 303, a second communication interface 304, a keyboard 305, a mouse 306, and a display unit 307, through a bus 308. For example, the storage unit 302 is the storage device such as the HDD, the SSD, and the like. The storage unit 302 stores a control program PR3 or various types of setting information for managing the self-POS terminal 2 by the attendant terminal 3.

The first communication interface 303 is an interface connected to the self-POS terminal 2, through the network N1. The second communication interface 304 is an interface connected to the portable terminal 4, through the network N2. The keyboard 305 is an input device that inputs various operations and includes character keys for inputting characters, numeric keys for inputting numbers, or the like. The mouse 306 is an input device for moving a cursor displayed on the display unit 307 and performing an operation according to a display element displayed by the display unit 307. The display unit 307, for example, is a liquid crystal display or the like.

Next, a hardware configuration of the portable terminal 4 will be described. FIG. 5 is a block diagram illustrating a hardware configuration of the portable terminal 4.

The portable terminal 4 includes a control unit 401 that integrally controls various calculation or each part of the portable terminal 4. The control unit 401 is configured by the CPU, the ROM, the RAM, the RTC, and the like. The ROM is a storage medium for storing various programs or data. The RAM is a storage medium for temporarily storing various programs, or a storage medium for rewriting various data. The RTC counts the current date and time.

The control unit 401 is connected to a storage unit 402, a communication interface 403, a display unit 404, and a touch panel 405, through a bus 406. For example, the storage unit 402 is the storage device such as the HDD, the SSD, and the like. The storage unit 402 stores a control program PR4 or various types of setting information for managing the self-POS terminal 2 by the portable terminal 4.

The communication interface 403 is an interface connected to the attendant terminal 3, through the network N2. For example, the display unit 404 is a liquid crystal display or the like. The touch panel 405 determines that an operation is input according to a display element displayed on the display unit 404, by detecting a location operated (touched) on the display unit 404. With this, the touch panel 405 receives an operation of a corresponding key, by operating a key displayed on the display unit 404.

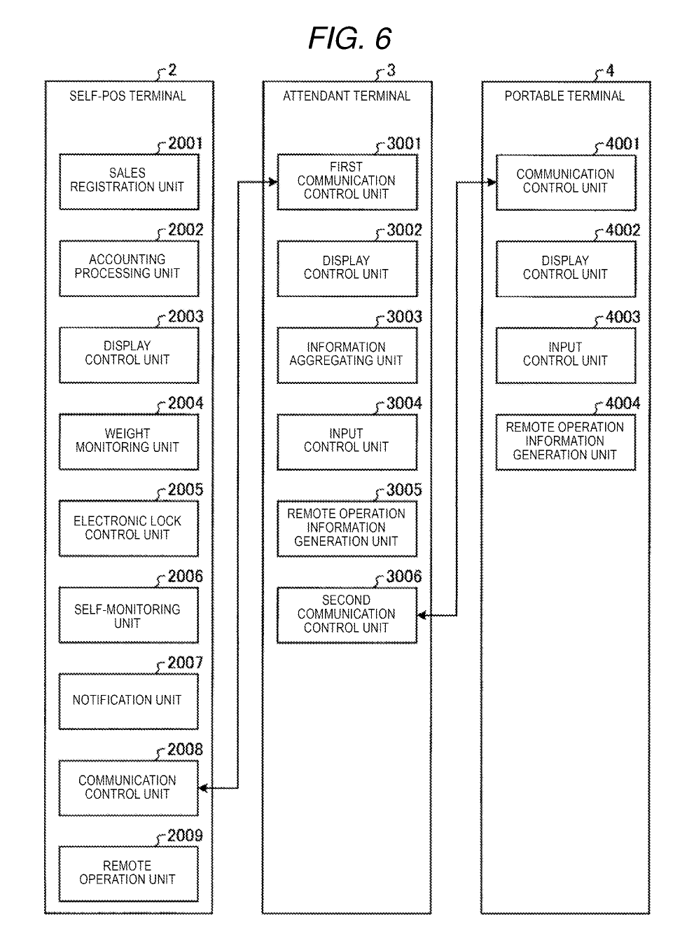

Next, characteristic functions included in each device of the self-checkout system 1 will be described. Here, FIG. 6 is a block diagram illustrating a function configuration included in each device of the self-checkout system 1.

First, a function configuration of the self-POS terminal 2 will be described.

The CPU of the control unit 221 expands the control program PR2 of the storage unit 222 to the RAM, and generates each functional unit illustrated in FIG. 6 on the RAM by performing an operation according to the control program PR2. Specifically, the control unit 221 includes a sales registration unit 2001, an accounting processing unit 2002, a display control unit 2003, a weight monitoring unit 2004, an electronic lock control unit 2005, a self-monitoring unit 2006, a notification unit 2007, a communication control unit 2008, and a remote operation unit 2009, as functional units.

The sales registration unit 2001 controls sales registration processing for registering the merchandise of the sales target in the merchandise sales data processing. That is, the sales registration unit 2001 registers the merchandise of the merchandise code received by the scanner 252 or the handy scanner 27 as the merchandise of the sales target. In addition, the sales registration unit 2001 calculates the total amount of price for the payment of the merchandise that is registered as a sales target.

The accounting processing unit 2002 performs the accounting processing of the merchandise of the sales target, by cooperating with the depositing and dispensing unit 20. That is, the accounting processing unit 2002 transmits the total amount of price calculated by the sales registration unit 2001 to the depositing and dispensing unit 20. The depositing and dispensing unit 20 accommodates the currency deposited from the coin slot 213 or the bill slot 215. Accordingly, the depositing and dispensing unit 20 dispenses a price in which the total amount of price calculated by the sales registration unit 2001 is subtracted from the price that is deposited from the coin payout opening 214 or the bill payout opening 216 as the change. At this time, the amount of the change may be calculated by the depositing and dispensing unit 20, and may be calculated by the accounting processing unit 2002.

The display control unit 2003 displays various screens on the display unit 26. For example, the display control unit 2003 displays a screen according to the sales registration processing, or a screen according to the accounting processing. In addition, the display control unit 2003 displays a screen notifying that an error is generated, or screen notifying that a clerk is called.

The weight monitoring unit 2004 monitors the weight of the merchandise placed on the first loading table 23 and the second loading table 24. With this, the weight monitoring unit 2004 determines whether or not the entirety of the merchandise before sales registration placed on the first loading table 23 is placed on the second loading table 24 by performing the sales registration. Accordingly, the weight monitoring unit 2004 can prevent dishonesty that the merchandise on which sales registration is not performed is placed on the second loading table 24. Accordingly, the weight monitoring unit 2004 determines that there is an abnormality on condition that there is a difference between the weight of the merchandise placed on the first loading table 23 and the weight of the merchandise placed on the second loading table 24. In addition, the weight monitoring unit 2004 determines that there is an abnormality on condition that the merchandise placed on the second loading table 24 is removed before the accounting processing. In addition, the weight monitoring unit 2004 determines that there is an abnormality on condition that the merchandise removed from the first loading table 23 is not placed on the second loading table 24 even after the lapse of a predetermined time.

The electronic lock control unit 2005 controls an electronic lock of each unit of the self-POS terminal 2. The electronic lock control unit 2005 unlocks the electronic lock of a corresponding location, according to an operation from the touch panel 261. That is, the electronic lock control unit 2005 unlocks at least one of the first electronic lock 225, the second electronic lock 226, the third electronic lock 227, according to an operation from the touch panel 261. In addition, the electronic lock control unit 2005 locks the first electronic lock 225, on condition that the first housing lower cover 211 is closed. In addition, the electronic lock control unit 2005 locks the second electronic lock 226, on condition that the first housing upper cover 212 is closed. In addition, the electronic lock control unit 2005 locks the third electronic lock 227, on condition that the second housing cover 251 is closed.

The self-monitoring unit 2006 monitors a state of the self-POS terminal 2 itself. Accordingly, the self-monitoring unit 2006 generates individual state information indicating a state of the self-POS terminal 2 itself. The individual state information includes operating state information, merchandise sales data processing state information, declaration state information, depositing and dispensing unit state information, and abnormal state information.

The operating state information is information indicating an operating state of the self-POS terminal 2. That is, the operating state information, for example, is information which illustrates any one of states in availability, in settlement, in registration, and in calling the clerk. The operating state information may include other states. The merchandise sales data processing state information is information indicating a state of the merchandise sales data processing. That is, the merchandise sales data processing state information is information including the merchandise that is registered, the total amount of price, or the like. The declaration state information is information indicating setting content that is set by the customer, when the self-POS terminal 2 is used. For example, the declaration state information is information of a setting or the like for using a shopping bag carried by the customer.

The depositing and dispensing unit state information is information indicating a state of the depositing and dispensing unit 20. That is, the depositing and dispensing unit state information is information including the number of sheets or the like for every money type of the change accommodated in the depositing and dispensing unit 20.

The abnormal state information is information indicating that an abnormality is generated in the self-POS terminal 2. That is, the abnormal state information, for example, is information indicating the abnormality that the merchandise which cannot be sold to minors such as alcohol, cigarettes, and the like is included in the sales target. In addition, the abnormal state information, for example, is information indicating abnormality determined by the weight monitoring unit 2004. In addition, for example, the abnormal state information is information indicating the abnormality of the printer 253 such as contents, paper jam, and the like according to the remaining amount of paper. In addition, the abnormal state information is abnormality indicating that the customer calls the clerk. In addition, the abnormal state information is abnormality indicating that the change which can be stored in the depositing and dispensing unit 20 is in any one of a full state, a near full state, an empty state, and a near empty state. The abnormal state information may be information indicating that other abnormalities occur.

The notification unit 2007 notifies on condition that it is determined that any one of the functional unit is in the abnormality state. The notification unit 2007 notifies the abnormality state by emitting sound, blinking the patrol lamp 29, or by displaying a notification screen (not illustrated) on the display control unit 2003. The notification unit 2007 displays the notification screen by overlapping a screen according to the sales registration processing or a screen according to the accounting processing with the notification screen, in a case where the notification screen is displayed on the display control unit 2003. Accordingly, the notification unit 2007 releases the notification, according to an operation from the touch panel 261. In addition, the self-monitoring unit 2006 cancels the notification, according to a request from the remote operation unit 2009.

The communication control unit 2008 communicates with the attendant terminal 3, by controlling the communication interface 223. Accordingly, the communication control unit 2008 that is a third transmission unit transmits the individual state information to the attendant terminal 3, whenever a certain period of time elapses. In addition, the communication control unit 2008 receives remote operation information from the attendant terminal 3. Here, the remote operation information is information for remotely operating the self-POS terminal 2 by the attendant terminal 3 or the portable terminal 4. Accordingly, the remote operation information includes identification information used for identifying the self-POS terminal 2, and operation information indicating operation content for the remote operation.

The remote operation unit 2009 performs processing according to the remote operation information. That is, the remote operation unit 2009 requests the cancellation of the notification to the notification unit 2007, on condition that the remote operation information indicates the cancellation of the notification. Specifically, the remote operation unit 2009 requests the cancellation of the notification according to weight error to the weight monitoring unit 2004, on condition that the remote operation information indicates the cancellation of the notification according to the weight error. In addition, the remote operation unit 2009 requests the cancellation of the notification according to the age verification to the self-monitoring unit 2006, on condition that the remote operation information indicates sales approval of alcohol or the like. In addition, the remote operation unit 2009 requests the cancellation of the notification according to printing error to the self-monitoring unit 2006, on condition that the remote operation information indicates the cancellation of the notification according to the printing error.

In addition, the remote operation unit 2009 unlocks the electronic lock of a corresponding location, on condition that the remote operation information indicates the unlock of the electronic lock. That is, the remote operation unit 2009 unlocks at least one of the first electronic lock 225, the second electronic lock 226, and the third electronic lock 227 by the electronic lock control unit 2005, on condition that the remote operation information indicates the unlock of the electronic lock.

Next, a function configuration of the attendant terminal 3 will be described.

The CPU of the control unit 301 generates each functional unit illustrated in FIG. 6 on the RAM, by expanding a control program PR3 of the storage unit 302 to the RAM, and being operated according to the control program PR3. Specifically, the control unit 301 includes a first communication control unit 3001, a display control unit 3002, an information aggregating unit 3003, an input control unit 3004, a remote operation information generation unit 3005, and a second communication control unit 3006, as functional units.

The first communication control unit 3001 communicates with the self-POS terminal 2, by controlling the first communication interface 303. Accordingly, the first communication control unit 3001 that is the first reception unit receives the individual state information indicating a state of the self-POS terminal 2 itself from a plurality of the self-POS terminals 2, whenever a certain period of time elapses. In addition, the first communication control unit 3001 that is the second transmission unit transmits the remote operation information to the self-POS terminal 2 indicated by the identification information of the remote operation information.

The display control unit 3002 displays various screens, by controlling the display unit 307. The display control unit 3002 displays a first management screen on the display unit 307, based on the individual state information transmitted from each of the self-POS terminal 2.

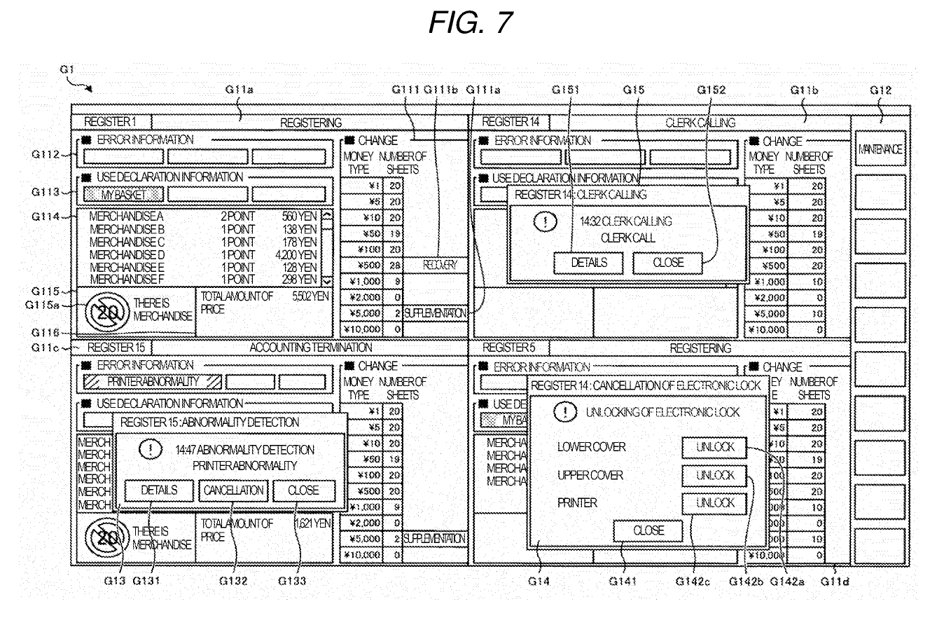

Here, FIG. 7 is an explanatory diagram illustrating an example of a first management screen G1. The first management screen G1 is a screen on which each state of the self-POS terminal 2 is displayed. The first management screen G1 includes self-POS terminal state display regions G11a, G11b, G11c, and G11d, and a maintenance display region G12, when being greatly classified. The self-POS terminal state display regions G11a, G11b, G11c, and G11d are regions on which each state of the self-POS terminal 2 is displayed. The self-POS terminal state display region G11a illustrated in FIG. 7 displays a state of the self-POS terminal 2 of the self-POS terminal number 1. The self-POS terminal state display region G11b illustrated in FIG. 7 displays a state of the self-POS terminal 2 of the self-POS terminal number 14. The self-POS terminal state display region G11c illustrated in FIG. 7 displays a state of the self-POS terminal 2 of the self-POS terminal number 15. The self-POS terminal state display region G11d illustrated in FIG. 7 displays a state of the self-POS terminal 2 of the self-POS terminal number 5. The maintenance display region G12 is a region on which various buttons for changing a setting of the self-POS terminal 2 are displayed.

Each of the self-POS terminal state display regions G11a, G11b, G11c, and G11d includes a change state display column G111, an error information display column G112, a use declaration information display column G113, a registration merchandise display column G114, a notice display column G115, and a total amount of price display column G116, respectively. The change state display column G111 is a column for displaying the number of sheets for every money type of the change accommodated in the depositing and dispensing unit 20. In addition, the display control unit 3002 displays a supplementation mark G111a in the money type required for the supplementation of the coins or bill. The display control unit 3002 displays the supplementation mark G111a on condition that the abnormal state information indicates that the change accommodated in the depositing and dispensing unit 20 is in the empty state or the near empty state. In addition, the display control unit 3002 displays the supplementation mark G111a, on condition that the number of sheets of the change accommodated in the depositing and dispensing unit 20 indicated by the depositing and dispensing unit state information is equal to or less than a threshold value. In addition, the display control unit 3002 displays a recovery mark G111b in the money type required for the recovery of the coins or bill. The display control unit 3002 displays the recovery mark G111b, on condition that the abnormal state information indicates that the change accommodated in the depositing and dispensing unit 20 is in the full state or the near full state. In addition, the display control unit 3002 displays the recovery mark G111b, on condition that the number of sheets of the change accommodated in the depositing and dispensing unit 20 indicated by the depositing and dispensing unit state information is equal to or greater than a threshold value.

The error information display column G112 is a column for displaying an error state of a corresponding self-POS terminal 2. Specifically, the display control unit 3002 displays the error of printer abnormality, the weight error, the abnormality error of the depositing and dispensing unit, or the like on the error information display column G112. That is, the display control unit 3002 displays the abnormality according to the error indicated by the abnormal state information on the error information display column G112.

When the customer uses the self-POS terminal 2, the use declaration information display column G113 is a column for displaying that the use is declared (registered). That is, the display control unit 3002 is a column for displaying information indicated by the declaration state information. For example, the display control unit 3002 displays a declaration (registration) that a shopping bag brought by the customer is used on the use declaration information display column G113.

The registration merchandise display column G114 is a column for displaying the merchandise registered as the merchandise of the sales target, in the merchandise sales data processing according to one transaction. The notices display column G115 is a column for displaying the notices to be noted by the clerk, in the merchandise sales data processing according to one transaction. The display control unit 3002, for example, displays a minor sale prohibition screen G115a indicating that the customer purchases the merchandise which cannot be sold to minors such as alcohol or cigarettes on the notice display column G115. The total amount of price display column G116 is a column for displaying the total amount of price of the merchandise of the sales target or the like, in the merchandise sales data processing according to one transaction.

In addition, the display control unit 3002 displays a pop-up screen on corresponding self-POS terminal state display regions G11a, G11b, G11c, and G11d for every self-POS terminal 2. With this, the clerk can immediately recognize whether the pop-up screen regards any of the self-POS terminal 2. Accordingly, for example, the display control unit 3002 displays the abnormality detection screen G13, the electronic lock unlocking screen G14, the clerk calling screen G15, or the like, as the pop-up screen.

The abnormality detection screen G13 is a pop-up screen for notifying the abnormality detected by the self-POS terminal 2. That is, the abnormality detection screen G13 is the pop-up screen for notifying the abnormality that the abnormal state information of the individual state information is indicated. The abnormality detection screen G13 includes a details button G131, a cancellation button G132, and a close button G133. The detail button G131 is a button for displaying an abnormality detail screen (not illustrated) on which the details of generated abnormality content are displayed. The cancellation button G132 is a button to be pressed in a case where there is no problem based on a result that the generated abnormality content is confirmed by the clerk. The close button G133 is a button to be pressed in a case where the abnormality detection screen G13 is deleted. The abnormality detection screen G13 illustrated in FIG. 7 indicates that the abnormality of the printer occurs.

The electronic lock unlocking screen G14 is a pop-up screen for unlocking the electronic lock of each part of the self-POS terminal 2 by a remote operation. The electronic lock unlocking screen G14 includes the close button G141 and unlocking buttons G142a, G142b, and G142c. The close button G141 is a button for deleting the electronic lock unlocking screen G14. The unlocking buttons G142a, G142b, and G142c are buttons for unlocking a corresponding electronic lock of the self-POS terminals 2. The unlocking button G142a is a button for unlocking the first electronic lock 225 that is the electronic lock of the first housing lower cover 211. The unlocking button G142b is a button for unlocking the second electronic lock 226 that is the electronic lock of the first housing upper cover 212. The unlocking button G142c is a button for unlocking the third electronic lock 227 that is the electronic lock of the second housing 25 in which the printer is accommodated.

The clerk calling screen G15 is a pop-up screen indicating that the customer using the self-POS terminal 2 calls the clerk. That is, the clerk calling screen G15 is the pop-up screen to be notified in a case where the abnormal state information of the individual state information indicates the calling of the clerk. The clerk calling screen G15 includes the detail button G151 and the close button G152. The detail button G151 is a button that displays the calling detail screen (not illustrated) on which the details of the reason for calling the clerk are displayed. The close button G152 is a button for deleting the clerk calling screen G15.

The first management screen G1 illustrated in FIG. 7 displays four self-POS terminal state display regions G11a, G11b, G11c, and G11d. However, the number of display regions is not limited thereto, may display equal to or less than three regions, and may display equal to or greater than five regions. In addition, the first management screen G1 illustrated in FIG. 7 displays states of the self-POS terminal number 1, the self-POS terminal number 14, the self-POS terminal number 15, and the self-POS terminal number 5. However, the clerk can arbitrarily set display of any state of the self-POS terminal 2.

Returning to FIG. 6, the information aggregating unit 3003 that is the generation means generates the entire state information to be transmitted to the portable terminal 4, by aggregating the individual state information received from the plurality of the self-POS terminals 2 by the first communication control unit 3001. The entire state information is information indicating each state of the plurality of the self-POS terminals 2 connected to the attendant terminal 3. Accordingly, the portable terminal 4 displays each state of the self-POS terminals 2, based on the entire state information.

The input control unit 3004 receives various operations from the keyboard 305, the mouse 306, or the like.

The remote operation information generation unit 3005 generates the remote operation information for remotely operating the self-POS terminal 2, based on the operation received by the input control unit 3004. The remote operation information includes the identification information capable of identifying the self-POS terminal 2 and operation information indicating the remote operation content with respect to the self-POS terminal 2 indicated by the identification information. Specifically, the remote operation information generation unit 3005 generates the remote operation information including the operation information for cancelling the notification according to the abnormality state of the self-POS terminal 2, on condition that the input control unit 3004 receives an operation for cancelling the notification according to the abnormality state of the self-POS terminal 2. In addition, the remote operation information generation unit 3005 generates the remote operation information including the operation information for unlocking the electronic lock of the self-POS terminal 2, on condition that the input control unit 3004 receives an operation for unlocking the electronic lock of the self-POS terminal 2.

The second communication control unit 3006 communicates with the portable terminal 4, by controlling the second communication interface 304. Accordingly, the second communication control unit 3006 that is a first transmission means transmits the entire state information generated by the information aggregating unit 3003 to the portable terminal 4, whenever a certain period of time elapses. The second communication control unit 3006 can transmit the entire state information to one or the plurality of portable terminals 4, in a case where a plurality of portable terminals 4 are connected through the network N2. In addition, the second communication control unit 3006 that is the second reception means receives the remote operation information from the portable terminal 4.

Next, a function configuration of the portable terminal 4 will be described.

The CPU of the control unit 401 expands a control program PR4 of the storage unit 402 to the RAM, and generates each functional unit illustrated in FIG. 6 on the RAM by performing an operation according to the control program PR4. Specifically, the control unit 221 includes a communication control unit 4001, a display control unit 4002, an input control unit 4003, and a remote operation information generation unit 4004, as the functional unit.

The communication control unit 4001 communicates with the attendant terminal 3, by controlling the communication interface 403. Accordingly, the communication control unit 4001 that is a third reception means receives the entire state information transmitted from the attendant terminal 3, whenever a certain period of time elapses. In addition, the communication control unit 4001 transmits the remote operation information to the attendant terminal 3.

The display control unit 4002 displays various screens by controlling the display unit 404. The display control unit 4002 that is a display control means displays a second management screen (not illustrated) on the display unit 307, based on the entire state information transmitted from the attendant terminal 3. The second management screen is a screen on which each state of the self-POS terminal 2 is displayed. That is, the second management screen is a screen in which the entirety or a part of the display elements to be displayed on a first management screen G1 are included. For example, the second management screen is a screen in which the self-POS terminal state display regions G11a, G11b, G11c, and G11d are displayed and the maintenance display region G12 is not displayed. Accordingly, for example, the display control unit 4002 displays one or a plurality of the self-POS terminal state display regions G11a, G11b, G11c, and G11d on the second management screen.

Furthermore, the display control unit 4002 displays the various pop-up screens displayed by the attendant terminal 3 by overlapping the second management screen, in the same manner as the attendant terminal 3. That is, for example, the display control unit 4002 displays a pop-up screen corresponding to an abnormality detection screen G13, an electronic lock unlocking screen G14, a clerk calling screen G15, or the like, as the pop-up screen. Furthermore, the display control unit 4002 displays a screen corresponding to an abnormality detail screen or a calling detail screen displayed by the attendant terminal 3.

The input control unit 4003 receives various operations from the touch panel 405 or the like.

The remote operation information generation unit 4004 generates the remote operation information for remotely operating the self-POS terminal 2, based on the operation received by the input control unit 4003. That is, the remote operation information generation unit 4004 generates the remote operation information including the identification information indicating the self-POS terminal 2 of a target to be remotely operated and the operation information indicating the remote operation content. Accordingly, the remote operation information generation unit 4004 generates the remote operation information including the operation information for cancelling the notification according to the abnormality state of the self-POS terminal 2, on condition that the input control unit 4003 receives an operation for cancelling the notification according to the abnormality state of the self-POS terminal 2. In addition, the remote operation information generation unit 4004 generates the remote operation information including the operation information for unlocking the electronic lock of the self-POS terminal 2, on condition that the input control unit 4003 receives an operation for unlocking the electronic lock of the self-POS terminal 2.

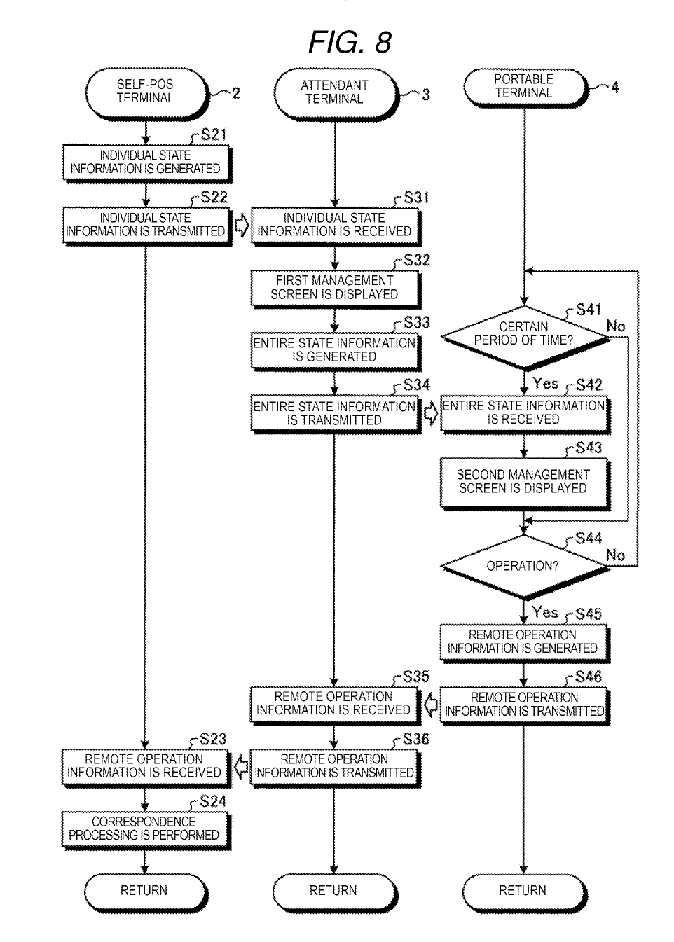

Next, management processing performed by each device of the self-checkout system 1 will be described. Here, FIG. 8 is a flowchart illustrating an example of the management processing performed by each device of the self-checkout system 1 of the embodiment.

First, the self-monitoring unit 2006 of the self-POS terminal 2 generates the individual state information (step S21). Subsequently, the communication control unit 2008 of the self-POS terminal 2 transmits the individual state information to the attendant terminal 3 (step S22).

Subsequently, the first communication control unit 3001 of the attendant terminal 3 receives the individual state information from the self-POS terminal 2 (step S31). Subsequently, the display control unit 3002 of the attendant terminal 3 displays the generated first management screen information (step S32).

Subsequently, the information aggregating unit 3003 of the attendant terminal 3 generates the entire state information by aggregating the individual state information transmitted from the self-POS terminal 2 (step S33). Subsequently, the second communication control unit 3006 of the attendant terminal 3 transmits the generated entire state information (step S34).

The communication control unit 4001 of the portable terminal 4 determines whether or not a certain period of time for receiving the entire state information elapses (step S41). On condition that the certain period of time does not elapse (step S41; No), the communication control unit 4001 of the portable terminal 4 proceeds to step S44.

Meanwhile, on condition that the certain period of time elapses (step S41; No), the communication control unit 4001 of the portable terminal 4 receives the entire state information transmitted from the attendant terminal 3 (step S42). Subsequently, the display control unit 4002 of the portable terminal 4 displays the generated second management screen (step S43).

Subsequently, the input control unit 4003 of the portable terminal 4 determines whether or not the operation is received (step S44). On condition that the operation is not received (step S44; No), the input control unit 4003 of the portable terminal 4 returns to step S41, and receives the entire state information again.

Meanwhile, on condition that the operation is received (step S44; Yes), the remote operation information generation unit 4004 of the portable terminal 4 generates the remote operation information according to the operation content (step S45). Subsequently, the communication control unit 4001 of the portable terminal 4 transmits the generated remote operation information to the attendant terminal 3 (step S46).

Subsequently, the second communication control unit 3006 of the attendant terminal 3 receives the remote operation information transmitted from the portable terminal 4 (step S35). Subsequently, the first communication control unit 3001 of the attendant terminal 3 transmits the remote operation information to the self-POS terminal 2 (step S36).

Subsequently, the communication control unit 2008 of the self-POS terminal 2 receives the remote operation information transmitted from the attendant terminal 3 (step S23). Subsequently, the remote operation unit 2009 of the self-POS terminal 2 performs processing corresponding to the remote operation information (step S24).

Thus, each device of the self-checkout system 1 terminates the management processing.

As described above, in the attendant terminal 3 according to the embodiment, the first communication control unit 3001 receives the individual state information indicating the state of the self-POS terminal 2 from the plurality of self-POS terminals 2. Accordingly, the information aggregating unit 3003 generates the entire state information indicating the state of the plurality of self-POS terminals 2, by aggregating the individual state information received from the plurality of self-POS terminals 2. The second communication control unit 3006 transmits the generated entire state information to the portable terminal 4. Therefore, the portable terminal 4 can display the state of the plurality of self-POS terminals 2 connected to the attendant terminal 3. Accordingly, the attendant terminal 3 according to the embodiment can easily confirm the state of various devices.

While some embodiments according to the invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In addition, in the embodiment, it is described that the electronic lock is installed with the first housing lower cover 211, the first housing upper cover 212, and the second housing cover 251. However, the self-POS terminal 2 may be provided with the electronic lock in a position other than these positions. For example, the depositing and dispensing unit 20 or the printer 253 itself may be provided with the electronic lock.

A program executed in each device in the embodiment or a modification example is provided by incorporating in advance in the storage medium (ROM or storage unit) included in each device. However, the invention is not limited thereto. For example, the program may be configured to be provided by being recorded in a computer readable recording medium such as a CD-ROM, a flexible disk (FD), a CD-R, a digital versatile disk (DVD), and the like in an installable format file or an executable format file. Furthermore, the storage medium is not limited to a medium independent from the computer or an embedded system, and also includes the storage medium temporarily stored or stored by downloading a program transmitted by the LAN, the Internet, or the like.

In addition, a configuration in which the program executed by each device in the embodiment or the modification example is stored on the computer connected to the network such as the Internet and the like, and provided by downloading through the network may be implemented, and a configuration in which the program is provided or distributed through the network such as the Internet and the like may be implemented.

What is claimed is:

1. An information processing device, comprising:
first reception means for receiving individual state information indicating a state of an accounting device performing accounting processing on merchandise on which sales registration is performed from a plurality of accounting devices;
generation means for generating entire state information indicating a state of each of the plurality of accounting devices receiving the individual state information by the first reception means, by aggregating the individual state information; and
first transmission means for transmitting the entire state information generated by the generation means to a portable terminal comprising a display unit.

2. The device according to claim 1, further comprising:
second reception means for receiving remote operation information comprising identification information capable of identifying the accounting device and remote operation content with respect to the accounting device indicated by the identification information from the portable terminal; and
second transmission means for transmitting the remote operation information received by the second reception means to the accounting device indicated by the identification information of the remote operation information.

3. The device according to claim 2, wherein
the second reception means receives the remote operation information comprising the remote operation content for cancelling notification according to an abnormality state generated in the accounting device, and
the second transmission means transmits the remote operation information received by the second reception means to the accounting device indicated by the identification information.

4. The device according to claim 2, wherein
the second reception means receives the remote operation information including the remote operation content for unlocking an electronic lock included in the accounting device, and
the second transmission means transmits the remote operation information received by the second reception means to the accounting device indicated by the identification information.

5. The device according to claim 3, further comprising:
a notification unit for notifying the abnormality state generated in the accounting device.

6. A management system, comprising:
an accounting device that performs accounting processing on merchandise on which sales registration is performed;
an information processing device that aggregates information transmitted from a plurality of accounting devices; and
a portable terminal that displays the information aggregated by the information processing device, wherein
the accounting device comprising third transmission means for transmitting individual state information indicating a state of the accounting device,
the information processing device comprising first reception means for receiving the individual state information from the plurality of accounting devices, generation means for generating entire state information indicating a state of each of the plurality of accounting devices receiving the individual state information by the first reception means, by aggregating the individual state information, and first transmission means for transmitting the entire state information generated by the generation means, and
the portable terminal comprising third reception means for receiving the entire state information, and a display control means for displaying a screen indicating the state of the accounting devices, based on the entire state information received by the third reception means.

7. The management system according to claim 6, further comprising:
second reception means for receiving remote operation information comprising identification information capable of identifying the accounting device and remote operation content with respect to the accounting device indicated by the identification information from the portable terminal; and
second transmission means for transmitting the remote operation information received by the second reception means to the accounting device indicated by the identification information of the remote operation information.

8. The management system according to claim 7, wherein
the second reception means receives the remote operation information comprising the remote operation content for cancelling notification according to an abnormality state generated in the accounting device, and
the second transmission means transmits the remote operation information received by the second reception means to the accounting device indicated by the identification information.

9. The management system according to claim 7, wherein
the second reception means receives the remote operation information comprising the remote operation content for unlocking an electronic lock included in the accounting device, and
the second transmission means transmits the remote operation information received by the second reception means to the accounting device indicated by the identification information.

10. The management system according to claim 7, wherein
each accounting device comprises a notification unit for notifying an abnormality state generated in the accounting device.

11. The management system according to claim 7, wherein
each accounting device comprises a notification unit for notifying an error state generated in the accounting device.

12. The management system according to claim 6, wherein
the screen of the portable terminal has a display region for each of a plurality of accounting devices.

13. The management system according to claim 6, wherein
the screen of the portable terminal displays a notification indicating an abnormality state is generated from the accounting device.

14. The management system according to claim 6, wherein
the screen of the portable terminal displays a notification indicating an error state is generated from the accounting device.

15. A management method, comprising:
performing accounting processing on merchandise;
aggregating information from a plurality of accounting processing transactions;
displaying the information aggregated from the plurality of accounting processing transactions on a portable terminal;
transmitting individual state information indicating a state of an accounting device performing accounting processing;
receiving the individual state information;
generating entire state information indicating a state of each of a plurality of accounting devices by aggregating the individual state information and transmitting the entire state information;
receiving the entire state information on the portable terminal; and
displaying a screen indicating the state of the accounting devices based on the entire state information received by the portable terminal.

16. The management method according to claim 15, further comprising:
receiving remote operation information comprising identification information capable of identifying the accounting device and remote operation content with respect to the accounting device indicated by the identification information from the portable terminal; and
transmitting the remote operation information received to the accounting device indicated by the identification information of the remote operation information.

17. The management system according to claim 16, further comprising:
receiving the remote operation information comprising the remote operation content for cancelling notification according to an abnormality state generated in the accounting device, and transmitting the remote operation information received to the accounting device indicated by the identification information.

18. The management system according to claim 16, further comprising:
receiving the remote operation information comprising the remote operation content for unlocking an electronic lock included in the accounting device and transmitting the remote operation information received by the second reception means to the accounting device indicated by the identification information.

19. The management method according to claim 15, further comprising:
displaying a notification indicating an abnormality state is generated from the accounting device on a screen of the portable terminal.

20. The management method according to claim 15, further comprising:
displaying a notification indicating an error state is generated from the accounting device on a screen of the portable terminal.
